(19) United States
(12) Patent Application Publication
(10) Pub. No.: US 2025/0197673 A1
(43) Pub. Date: Jun. 19, 2025

(54) Plant-Based Wax Composition

(71) Applicant: BETULIUM OY, Espoo (FI)

(72) Inventors: Nikolaos PAHIMANOLIS, Espoo (FI); Antti LAUKKANEN, Espoo (FI); Henrikki MERTANIEMI, Espoo (FI); Marko LAURAEUS, Espoo (FI)

(21) Appl. No.: 18/849,382

(22) PCT Filed: Mar. 24, 2023
(86) PCT No.: PCT/FI2023/050167

§ 371 Date: Sep. 20, 2024

(30) Foreign Application Priority Data
Mar. 24, 2022 (FI) 20225255

(51) Int. Cl. C09D 191/06; C09D 7/40; C09D 101/02

(52) U.S. Cl. CPC C09D 191/06; C09D 7/70; C09D 101/02

(57) ABSTRACT

A composition, a method for manufacturing the composition, and products containing the composition are disclosed. The present composition is a dispersion comprising a plant-based wax and a fibrillated cellulose component. Additionally, a solid wet product and a use of the said composition is disclosed.

### TECHNICAL FIELD

The present disclosure generally relates to a wax composition. The disclosure relates particularly, though not exclusively, to plant-based wax compositions comprising fibrillated cellulose.

### BACKGROUND

This section illustrates useful background information without admission of any technique described herein representative of the state of the art.

The prior art describes using petroleum-derived waxes and synthetic waxes for incorporation into emulsions and dispersions. Given that the world's oil supply is finite, and is being depleted, there is a recognized and long-felt need to find alternatives to petroleum-derived products, such as petroleum waxes, that are derived from limited natural resources whose supply is being diminished. It is desirable to have a wax that can be obtained from a renewable source, such as plants, rather than being petroleum based.

Petroleum waxes such as paraffin and microcrystalline wax are used extensively by themselves and in combination with asphalt emulsions, montan wax, polyvinyl alcohol copolymers, and other hydrophobic materials, to improve product properties. Other waxes, for example, synthetic waxes such as Fischer Tropsch, and polyethylene waxes have also been used for this purpose with mixed results.

Dispersions prepared using a wax are used in a variety of applications, such as in sizing and in coating fibrous cellulosic products, such as paper, corrugated cardboard, liner board, kraft paper, boxboard and the like, to render their properties.

A common first step in the process of producing wax emulsions or dispersions is to dissolve the wax and add sufficient base to saponify the desired number of functional groups on the wax. Surfactant is then added, and the emulsion is allowed to form under good agitation.

The prior art shows that the microfibrillated cellulose has the unique capability of enhancing the stability of a wide variety of compositions. Microfibrillated cellulose has been used for instance in compositions of the type used in foods, cosmetics, pharmaceuticals and such industrial products as paints and drilling muds.

In nature, native cellulose is always in a microfibrillar form, being part of wall structures of the plant cell. In primary cell walls, especially in parenchyma cells, cellulose microfibrils are distributed randomly forming a flexible membrane layer together with other polysaccharides, such as pectin and hemicelluloses. In the secondary cell walls, the microfibrils are highly aligned mostly in the same direction and tightly bound to each other through hydrogen-bonding and covalent lignin bridges, forming a very rigid structure.

Cellulose microfibrils located either in primary or secondary walls are structurally similar. Both type of microfibrils consist of highly aligned cellulose macromolecule chains forming mechanically strong cellulose crystals with hydrogen bonded parallel polymer chains. The microfibrils are generally considered to contain only few faults along their axis, although the degree of crystallinity varies between plant species being generally higher for microfibrils obtained from secondary walls. It is commonly understood that, depending on the plant species, 18, 24, or 36 cellulose chains form the smallest aligned structure, which is known as cellulose elementary fibril having diameter of a few nanometers and lengths up to tens of micrometers.

It is an object of the present disclosure to provide a composition which at least alleviates present problems encountered in conventional solutions.

### SUMMARY

The appended claims define the scope of protection. Any example or technical description of an apparatus, product and/or method in the description and/or in a drawing which is not covered by the claims is presented not as an embodiment of the invention but as background art or example useful for understanding the invention.

The present inventors have unexpectedly discovered that plant-based waxes can be used effectively as substitutes for conventional petroleum and synthetic waxes in various applications. The present invention relates to a composition comprising plant-based wax and a fibrillated cellulose component that can be incorporated into various paper, board or wood products through conventional means.

According to a first example aspect there is provided a composition comprising:
a plant-based wax;
a fibrillated cellulose component; and
wherein the composition is a dispersion of wax particles in an aqueous medium.

In an embodiment, the fibrillated cellulose component comprises fibrillated cellulose containing entangled cellulose microfibril aggregates comprising microfibrils and/or microfibril bundles which are smaller than 200 μm. Preferably, during manufacturing of the composition the fibrillated cellulose component is added as a suspension in an aqueous medium, such as in water.

In an embodiment, the fibrillated cellulose comprises cellulose nanofibrils comprising nanofibrils and/or nanofibril bundles which are smaller than 200 μm, produced by a method described in WO 2022/003252 A1 publication Examples, especially in the Examples 1 and 3, or the method presented in WO 2017/103329 A1 publication Examples, especially in the Examples B and C.

In an embodiment, the fibrillated cellulose comprises cellulose nanofibrils having anionic or cationic groups attached to surfaces, produced by a method described in WO2018/202955, see in particular Examples 4-6 for anionization, and Examples 2-3 for cationization.

In an embodiment, the fibrillated cellulose comprises cellulose nanofibrils having phosphate ester, sulfate ester or hydroxypropyl trimethylammonium halide ether groups, said groups being preferably covalently attached to the cellulose.

In an embodiment, the fibrillated cellulose component is fibrillated parenchymal cellulose.

In the context of the present invention, the composition is an emulsion during the production of it, whereas the final product is a dispersion. In an embodiment, the dispersion is a colloidal dispersion.

In an embodiment, the plant-based wax comprises saponified triglycerides and/or partially saponified triglyceride. In an embodiment the plant-based wax comprises triglycerides and/or partially saponified triglyceride, and the plant-based wax is preferably selected from the group consisting of palm wax, palm kernel wax, rapeseed wax, soy wax, corn wax, canola wax, carnauba wax, candelilla wax, ourieury wax, soybean wax, coconut wax, cranbe wax, sunflower wax, linseed wax, cottonseed wax, sugar cane wax, bayberry wax, peanut wax, or a combination thereof.

In an embodiment, the plant-based wax comprises completely saponified triglyceride or fatty acids.

In an embodiment the plant-based wax comprises partially hydrogenated tall oil acid, completely hydrogenated tall oil acid, crude tall oil, distilled tall oil, or any mixture thereof. An advantage of using such tall oil derived product is that it enables omitting the saponification step, and makes possible to use blends of such tall oil derived products with plant oils as the plant-based wax. Additionally, with these plant-based waxes it is possible to manufacture even fully wood-based paper products that have good barrier properties.

In an embodiment the plant-based wax comprises partially hydrogenated tall oil acid having an iodine number in the range 45-65 g (I2)/100 g, preferably 50-60 g (I2)/100 g, more preferably about 54 g (I2)/100 g, most preferably about 54 g (I2)/100 g.

In an embodiment plant-based wax comprises partially hydrogenated tall oil acid having a melting point in the range 50-60° C., preferably 53-55° C.

In an embodiment, the plant-based wax is hydrogenated, or partially hydrogenated.

In an embodiment, the fibrillated cellulose may contain other polysaccharides, such as pectin, hemicellulose, and/or other soluble polysaccharides present in the cellulose raw material from which the fibrillated cellulose component is manufactured. In an embodiment no further polysaccharides are added to the fibrillated cellulose component and/or to the composition.

Unless otherwise indicated, all percentage values refer to wt-% of a dry product.

In an embodiment, the fibrillated cellulose component comprises cellulose in an amount of less than 70 wt-%, preferably less than 65 wt-% dry matter of the fibrillated cellulose component, and hemicelluloses in an amount of more than 30 wt-%, preferably more than 35 wt-% dry matter of the fibrillated cellulose component. In an embodiment, the fibrillated cellulose component may additionally comprise starch.

In an embodiment, the fibrillated cellulose component comprises cellulose in an amount of less than 60 wt-%, preferably less than 55 wt-% dry matter of the fibrillated cellulose component, and hemicellulose in an amount of more than 40 wt-% preferably more than 45 wt-% dry matter of the fibrillated cellulose component.

In an embodiment, the fibrillated cellulose component comprises cellulose in an amount of less than 50 wt-%, preferably less than 45 wt-% dry matter of the fibrillated cellulose component, and hemicellulose in an amount of more than 50 wt-% preferably more than 55 wt-% dry matter of the fibrillated cellulose component.

In an embodiment, the fibrillated cellulose component comprises cellulose in an amount of preferably less than 25 wt-% dry matter of the fibrillated cellulose component, and hemicellulose in an amount of preferably more than 50 wt-% dry matter of the fibrillated cellulose component.

In an embodiment, the fibrillated cellulose component comprises cellulose in an amount of preferably more than 50 wt-% dry matter of the fibrillated cellulose component, and hemicellulose in an amount of preferably less than 50 wt-% dry matter of the fibrillated cellulose component.

In an embodiment, in the fibrillated cellulose component the amount of the fibrillated cellulose component is selected from the range 50-70 wt-% dry matter of the fibrillated cellulose component.

In an embodiment, in the fibrillated cellulose component the amount of hemicellulose is selected from the range 30-50 wt-% dry matter of the fibrillated cellulose component.

In an embodiment, in the fibrillated cellulose component the amount of the fibrillated cellulose component is selected from the range 50-70 wt-% dry matter of the fibrillated cellulose component, and the amount of hemicellulose is selected from the range 30-50 wt-% dry matter of the fibrillated cellulose component.

In an embodiment, the composition comprises an additional anionic, cationic, zwitterionic, or amphiphilic surfactant or polymer, or hydrophilic polymer of synthetic or natural origin.

In an embodiment, the composition comprises at least one complexing agent, such as ethylenediaminetetraacetic acid (EDTA) or at least one citrate salt.

In an embodiment, the composition further comprises multivalent cations, preferably at least one of Zn²⁺, Mg²⁺, Cu²⁺, Fe²⁺, Fe³⁺, Al³⁺, Sn²⁺, and Ca²⁺, a fatty acid salt of the multivalent cation, or any combination thereof. By including a multivalent cation or its fatty acid salt, it is possible to increase hydrophobicity and oleophobicity and/or introduce antimicrobial or microbicidal properties. The multivalent cation, such as Ca²⁺ can be added into the composition under high-shear mixing. Preferably an aqueous solution of the multivalent cation is added under high-shear mixing to the composition.

In an embodiment, the composition further comprises at least one thermoplastic polymer. Preferably the thermoplastic polymer is selected to improve at least one of elasticity, thermoplasticity, and heat sealability. Examples of suitable thermoplastic polymers include polyolefin dispersion, polyester, polyamide, polycaprolactone, polylactic acid, ethylene copolymers, ethylene terpolymers, polyvinyl acetate latex, ethyl vinyl acetate latex, styrene butadiene latex, styrene acrylate latex, acrylate latex, methyl methacrylate latex, or any of their mixtures, or copolymers or derivatives thereof.

In an embodiment, the composition further comprises synthetic wax, such as polyolefin wax, fatty amide wax, amide wax, inorganically modified wax, oxidized polyethylene wax, or their combination.

In an embodiment, the wax dispersion is produced directly after hydrogenation of the oil.

In an embodiment, the wax composition comprises a non-hydrogenated vegetable triglyceride and/or non-hydrogenated fatty acid, or their combination.

In an embodiment, the composition further comprises at least one natural, synthetic or semi-synthetic polymer, such as carboxymethyl cellulose, hydroxypropyl cellulose, hydroxypropyl methyl cellulose, methyl cellulose, hydroxyethyl cellulose, hydroxyethyl methyl cellulose, hydroxyethyl hydroxypropyl cellulose, quaternized hydroxyethyl cellulose, carboxymethyl starch, hydroxypropyl starch, hydroxypropyl methyl starch, hydroxyethyl starch, hydroxyethyl methyl starch, hydroxyethyl hydroxypropyl starch, hydroxypropyl trimethylammonium chloride starch, dextrin, starch, xanthan gum, guar guar, agar agar, alginate, tylose, polyvinyl alcohol, polyacrylamide, vinyl acetate copolymer, or any combination thereof.

In an embodiment, the composition further comprises at least one non-ionic surfactant, such as cetyl alcohol, stearyl alcohol, cetostearyl alcohol, alcohol ethoxylate, polyglycol ether, polyoxyethylene alkyl ether, secondary alcohol ethoxylate, polyoxyethylene alkyl ether, polyalkyl glycol alkyl ether, ester of pentaerythritol, sugar ester of pentaerythritol, fatty acid, citric acid, fatty acid citrate, fatty alcohol, or any combination thereof.

In an embodiment, the composition further comprises at least one ionic surfactant containing phosphate, sulfate sulfonate, sulfate carboxylate, for example sodium lauryl sulfate, ammonium lauryl sulfate, lauryl ether sulfate, lecithin, alkali salt of tall oil, or any combination thereof.

In an embodiment, the plant-based wax is essentially solid in the room temperature. In a further embodiment, the melting point of the composition is higher than 30° C., preferably higher than 50° C., more preferably between 50° C.-90° C.

In an embodiment, the composition comprises wax particle sizes of less than 20 μm, preferably between 0.1-10 μm, most preferably between 0.5-8 μm.

In an embodiment, the particle size of the wax particles in the composition is adjusted by the type and the power of mixing. In an embodiment, the composition is subjected to high shear mixing.

In an embodiment, the dispersion of the wax particles has a Brookfield viscosity of 10 cP-6000 cP determined for aqueous 20 wt-% dry matter of the composition, 50 rpm, spindle V-73.

In an embodiment, the composition is produced into a solid wet product. This can be achieved by dehydration.

The composition of the first aspect is able to improve one or more properties of the product when applied on the product, and it can improve processing properties of compositions when mixed with them. These properties comprise, not exclusively, barrier properties, moisture resistance, water resistance, hydrophobicity, oleophobicity, durability, printing properties, inhibiting water absorption, and improved processing properties, such as a higher melting point, lower viscosity, and thermal stability.

According to a second aspect is provided a solid wet product obtained by subjecting the composition of the first aspect to a powder-making process.

In an embodiment, the solid wet product is obtained by cooling and optionally drying the composition. In an embodiment, the solid wet product has a water content of 30-80 wt-% of the total weight of the solid wet product. In an embodiment, the solid wet product is a solidified dispersion. In an embodiment, the powder-making process is granulation, grinding, pelleting, cubing, or any suitable technique to reduce particle size. In an embodiment, the said optional drying is selected from the group consisting of freeze drying, lyophilization, vacuum drying, air drying, spray drying, atomization, evaporation, tray drying, flash drying, drum drying, fluid-bed drying, oven drying, belt drying, microwave drying, solar drying, or any combination thereof.

According to a third aspect is provided a method for production the composition of the first aspect, comprising:
providing a plant-based wax;
providing a fibrillated cellulose component;
heating the plant-based wax and the fibrillated cellulose component;
adding the fibrillated cellulose component to the plant-based wax while continuously mixing;
mixing the fibrillated cellulose component and the plant-based wax until a phase transition occurs to obtain the composition of dispersion of wax particles in an aqueous medium.

In an embodiment the plant-based wax and the fibrillated cellulose component are heated separately before mixing.

In an embodiment when the plant-based wax is a blend of triglycerides and at least one of acid, partially hydrogenated tall oil acid, completely hydrogenated tall oil acid, crude tall oil, and distilled tall oil, the step of providing a plant-based wax includes heating and mixing to obtain a blend. The skilled person can use Example 12 as instructions to manufacture any blend from the plant-based wax components described herein.

According to an alternative third aspect is provided a method for manufacturing the composition of the first aspect, comprising:
providing a plant-based wax dispersion;
providing a fibrillated cellulose component; and
adding the fibrillated cellulose component to the dispersion while continuously mixing to obtain a dispersion of wax particles in an aqueous medium.

In an embodiment, when carrying out the step of providing the plant-based wax dispersion, the plant-based wax is heated with mixing, mixed with a solution of polymer and/or surfactant which is preferably polyvinyl alcohol, and then cooled followed by high-shear mixing. When this dispersion is mixed with the fibrillated cellulose component in the next step, a composition is obtained which has good water barrier and oil barrier properties when used as a coating. In the method the aqueous medium of the present composition is provided by the added solution of the polymer, the surfactant, or the fibrillated cellulose component. In an embodiment the solution of polymer and/or surfactant is in an aqueous phase or an aqueous medium.

In an embodiment, additional fibrillated cellulose component is added to dispersion of wax particles in the aqueous medium.

In an embodiment, the fibrillated cellulose component is added to the plant-based wax in a continuous manner. In an embodiment, the fibrillated cellulose component is added to the plant-based wax in a gradual manner. In an embodiment, the fibrillated cellulose component is added to the plant-based wax all at once.

In an embodiment, the fibrillated cellulose component comprises entangled cellulose microfibril aggregates comprising microfibrils and/or microfibril bundles which are smaller than 200 μm.

In an embodiment, the method is performed with the Emulsion Inversion Point method.

In an embodiment, the solid wet product is a solid wet powder. In an embodiment, the solid wet product is re-dispersible by heating or diluting the solid wet product.

In an embodiment, the fibrillated cellulose comprises cellulose nanofibrils comprising nanofibrils and/or nanofibril bundles which are smaller than 200 μm.

In an embodiment, the fibrillated cellulose comprises cellulose nanofibrils having anionic or cationic groups attached to its surfaces.

In an embodiment, the fibrillated cellulose comprises cellulose nanofibrils having phosphate ester, sulfate ester or hydroxypropyl trimethylammonium halide ether groups.

According to a fourth aspect is provided method for producing a liquid dispersion, comprising providing the solid wet product of the second aspect, diluting the solid wet products in an aqueous medium, or heating the solid wet product, to obtain the liquid dispersion.

In an embodiment, the method for producing a liquid dispersion further comprises mixing of the heated of diluted solid wet product.

According to a fifth aspect if provided a coating formulation, comprising the composition of the first aspect. In an embodiment, the formulation further comprises hot or cold soluble starches, other viscosity modifiers, pigments or fillers such as clay, titanium dioxide, kaolinite, calcium carbonate, bentonite, talc, or any combination thereof.

In an embodiment, the present composition is used as an ingredient in a coating or adhesive formulation. In an embodiment, the said coating or adhesive formulation further comprises at least one thermoplastic polymer in dissolved or latex form. In an embodiment, the said coating or adhesive formulation forms a heat-sealable layer after drying.

In an embodiment, the composition is used in paper or board coating process, such as in spray coating, blade coating, bar coating, film coating, or curtain coating. The coating can be applied on one side of the paper or board, or on both sides to provide coated paper or coated board. The coating can comprise one or more layers.

In an embodiment, the composition is used as a coating of fruits, berries, vegetables, or other edible substances to form an edible coating. In an embodiment, the composition is used as a coating or ingredient of various feed formulations such as feed pellets or granulated functional components such as vitamins.

According to a sixth aspect is provided an article of manufacture, wherein the article comprises a cellulosic medium, and wherein the article comprises at least one layer of coating of the composition of the first aspect.

According to a seventh aspect is provided a use of the composition of the first aspect in sizing, internal sizing, paper coating, board coating, barrier coating, hydrophobic coating, oleophobic coating, corrugated board production, gypsum board production, wood panel production, hard- or soft board production, laminated veneer lumber production, and/or chip board production.

In an embodiment, the composition comprising plant-based wax and a fibrillated cellulose component is used in paints, coatings and inks to meet a wide range of performance requirements. The performance requirements comprise imparting excellent rub resistance and toughness, scratch resistance, abrasion, and block resistance, as well as slip and rub resistance.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows a flow diagram for process steps for producing a wax product.

FIG. 2 schematically shows a process configuration for producing a MFC stabilized wax dispersion.

FIG. 3 shows optical microscopy images of wax dispersions.

FIG. 4 shows a coating test made with a wax dispersion on a laminated veneer lumber.

### DETAILED DESCRIPTION

As used herein, the term “comprising” includes the broader meanings of “including”, “containing”, and “comprehending”, as well as the narrower expressions “consisting of” and “consisting only of”.

In the following description, like reference signs denote like elements or steps.

The compositions of the present invention comprise plant-based wax, and a fibrillated cellulose component. The term wax is used to denote a solid substance consisting usually of hydrocarbons with a range of carbon numbers with C16-C28. Often the same compound may be referred to as an oil depending on the ambient temperature, the chain lengths of the esterified fatty acids, and their degree of saturation or unsaturation.

The term “triglycerides” refers to fatty acid esters of glycerol. Generally, the greater the degree of saturation and the longer the chain length of the esterified acids, the higher will be the melting point of the triglyceride.

In the context of the present invention, the plant-based wax is a wax originated in plants, or an oil originated in plants, which oil may be hydrogenated into a plant-based wax.

In the context of the present invention, the composition is an emulsion during the production process. In the context of the present invention, the final composition is a dispersion of wax particles in an aqueous medium at room temperature. An emulsion is a system of two immiscible liquids, dispersed together, containing droplets with high surface area.

In an embodiment, the dispersion is a colloidal dispersion. A colloidal dispersion is composed of solid particles dispersed in a continuous liquid phase.

The choice of a wax for a particular application is determined by whether it is a liquid or solid at the temperature of the product with which it is to be used. Among the factors that determine whether a wax is liquid or solid at a given temperature are properties such as the degree of saturation or unsaturation, or length of the hydrocarbon chain of the components of the wax, primarily the fatty acids.

In an embodiment, the plant-based wax is essentially solid in the room temperature. In an embodiment, the melting point of the composition is higher than 30° C., preferably higher than 50° C., more preferably between 50° C.-90° C.

The plant-based wax is obtained preferably from at least one plant source. The wax obtained from the plant source is selected from the group consisting of palm wax, palm kernel wax, rapeseed wax, soy wax, corn wax, canola wax, carnauba wax, candelilla wax, ourieury wax, soybean wax, coconut wax, cranbe wax, sunflower wax, linseed wax, cottonseed wax, sugar cane wax, bayberry wax, peanut wax, or a combination thereof. It is possible to employ combinations of waxes in the embodiments. These combinations could employ one or more waxes. The plant-based wax is used after normal refining processing by methods known in the art. For example, plant-based wax may be obtained by solvent extraction of plant biomass using aliphatic solvents. Subsequent additional purification may involve distillation, fractional crystallization, degumming, bleaching, and/or steam stripping.

In an embodiment, the plant-base wax is partially or fully hydrogenated. The plant based-wax may comprise one or more different plant-based waxes. The plant-based wax may comprise only hydrogenated waxes. The plant-based wax may comprise one or more hydrogenated waxes in combination with one or more non-hydrogenated waxes, to obtain a partially hydrogenated plant-based wax component.

When hydrogenated to a high degree, the properties of waxes are modified, having high melting points, low viscosity and good hardness. Suitable hydrogenated waxes have fatty acids with a range of carbon numbers with C16-C28. Furthermore, fatty acids may be obtained by hydrolysis of natural triglycerides, for instance by alkaline hydrolysis followed by purification methods known in the art, including distillation and steam stripping. The degree of unsaturation (or saturation) of the wax can be determined as an iodine value. The iodine value is expressed as grams of iodine absorbed 100 grams of the wax. In an embodiment, the iodine value of the plant-based wax is between 0.1-200, preferably between 1-80, more preferably 1-40.

In an embodiment, the plant-based wax comprises fatty acid amides. The plant-based wax comprising triglycerides can be subjected to aminolysis. Aminolysis is performed by any known practice, such as using sodium methoxide as catalyst and organic amine at 100° C. to yield fatty acid amides.

In an embodiment, the composition further comprises In an embodiment, the composition further comprises multivalent cations, preferably at least one of Zn²⁺, Mg²⁺, Cu²⁺, Fe²⁺, Fe³⁺, Al³⁺, Sn²⁺, and Ca²⁺, or any combination thereof. The hydrophobic and oleophobic properties of the wax composition may be adjusted with multivalent cations. The multivalent cations remove the excess of the negative charge present in the surfactants, thus reducing their surface activity. This reduces the hydrophilicity of the surfactants in the composition, which increases the hydrophobicity of the composition. The multivalent cations may act as crosslinkers between the fatty acids in the composition, which increases the stability of the composition.

In an embodiment, the wax's functional groups are saponified. Bases used to saponify functional groups of the wax include potassium hydroxide (KOH), sodium hydroxide (NaOH), calcium hydroxide, sodium silicates and amines such as ammonia, diethyl amine (“DEA”) and other amine derivatives. A surfactant may be generated in situ during the saponification process of the wax. The surfactant may be generated in the wax by the saponification of the wax using for instance potassium hydroxide.

Generally, a wax with a minimum saponification value of about 20-30 mg KOH/g wax can be readily emulsified. The saponification value, or number, represents the quantity, in milligrams of KOH which react with one gram of wax under elevated temperatures, and indicates the amount of free carboxylic acid plus any esters which may be saponified. This value, and the acid number, described below, provide an indication of the free carboxylic acid and ester content of the wax. The ASTM D1387 (2019) is an example of how a saponification number is determined. The ASTM D1386 (2016) represents a method to determine the acid number; the quantity, in milligrams, of KOH necessary to neutralize one gram of wax, indicating the amount of free carboxylic acid present.

The waxes of the present invention are highly functional having a saponification value of approximately 170 mgKOH/g-220 mgKOH/g. The high saponification value allows for conversion of the wax into emulsion form, in contrast to petroleum and/or asphalt wax which first is often oxidized to render the molecule functional to facilitate emulsification or dispersion. Because the waxes of the present invention do not require such processing, this also renders the present invention more economical than petroleum derived waxes.

If a plant-based wax contains hydrogenated tall oil, there is no need to saponify the plant-based wax component that usually contains partially saponified triglycerides in the absence of hydrogenated tall oil. Consequently, non-saponified triglycerides can be used in the plant-based wax as a blend with hydrogenated tall oil, instead of using at least partially saponified triglycerides alone.

In an embodiment, the composition described herein may be formulated to have a certain ionic charge. The wax composition may comprise an additional surface-active agent, which will be a surfactant, or other surface-active compound. An additional surface-active agent may be either cationic, nonionic, or anionic, depending upon the properties desired for the particular dispersion. In an embodiment, the additional surface-active agent is an additional surfactant. In an embodiment, the additional surfactant may be a bio-based surfactant, such as lecithin. Lecithin is an amphipathic surfactant. In another embodiment, the additional surfactant may be a synthetic surfactant.

Examples of suitable surface-active agents comprise alkyl ether carboxylates, alkyl sulfonates, sulfonated polyoxyethylenated sulfated alcohol, or phosphated polyoxyethylenated alcohols, polymeric ethylene oxide/propylene oxide/ethylene oxide, primary and secondary alcohol ethoxylates, alkyl glycosides and alkyl glycerides, fatty alcohols, cetyl alcohol, stearyl alcohol, cetostearyl alcohol, oleyl alcohol, mixed esters of pentaerythritol, fatty acids, citric acid and fatty alcohol and/or mixed esters of fatty acids, methyl glucose and polyols, preferably glycerol or polyglycerol; sorbitan mono- and diesters of saturated and unsaturated fatty acids and ethylene oxide addition products thereof; polyol esters and, in particular, polyglycerol esters, fatty acid esters of sugar alcohols, alkyl glucosides and polyglucoside mixed esters, such as glyceryl stearate citrate and glyceryl stearate lactate, or any combination thereof.

Examples of surface-active agents of particular interest comprise sodium dodecyl sulfate, sodium stearate, sodium lauryl ether sulfate, dioctyl sodium sulfosuccinate, alkylbenzene sulfonates, lignosulfonate, polyoxyethylene glycol octylphenol ethers, polyoxyethylene glycol alkylphenol ethers, polyoxyethylene glycol sorbitan alkyl esters, sorbitan alkyl esters, betaines, sultaines, nonylphenol ethoxylated, nonylphenol ethoxylated sulfate, laurylic alcohol ethoxylated, polyethylene glycol, polypropylene glycol, and their copolymers or block copolymers and oligomers, ethylene acid polymers such as ethylene acrylic acid copolymers or ethylene methacrylic acid copolymers, polysiloxane/polyalkyl/polyether copolymers and corresponding derivatives. vinyl acetate, vinyl acrylate, methacrylate copolymers and esters, derivatized cellulose or starch ethers and esters, such as carboxymethyl, hydroxyethyl, hydroxypropyl ethers or mixed ethers of cellulose or starch, olysaccharides, more especially xanthan gum, guar guar, agar agar and alginates, or any combination thereof.

The usage of an additional surfactant may replace the need for saponification of the wax, and when having an additional surfactant in the composition the plant-based wax may comprise non-saponified triclycerides, or it can comprise both saponified and non-saponified triglycerides. Alternatively, the usage of an additional surfactant may supplement to the previously obtained saponification of the wax. In an embodiment, the viscosity of dispersions can be reduced by using an additional surfactant.

In an embodiment, the wax dispersion has a positive surface charge or carries a cationic charge on the surface of the wax particle. In an embodiment, the positive or cationic surface charge is achieved by using cationic surfactant. In an embodiment, the cationic surface charge is achieved by using cationic polymers, such as cationic polyacrylamide, cationic starch, or another suitable cationic polymer. In an embodiment, the cationic surface charge is achieved by using cationic fibrillated cellulose.

In an embodiment, the compositions described herein comprise wax particle sizes of less than 20 μm. In an embodiment, the compositions described herein comprise wax particle sizes of preferably between 0.1-10 μm. In an embodiment, the compositions described herein comprise wax particle sizes of most preferably between 0.5-8 μm. In another embodiment the wax particles have a size of about 1-5 μm, or about 1.5-4.5 μm. The particle size of the wax particles in the composition can be adjusted by mechanical agitation or by a surfactant. The particle size of the wax particles in the composition can be adjusted by the type and the power of mixing. When manufacturing a composition with a more defined wax particle size, a suitable mixing power is needed during the manufacturing of the composition, especially in the stage when the plant-based wax and the water containing fibrillated cellulose component are forming an emulsion at temperatures above the melting point of the wax.

The slower or weaker the mixing, the larger the particle size of the wax particles in the composition. In an embodiment, the composition is subjected to high shear mixing, such as 17 kRPM and 10 KJ/dm³ energy feed, in order to gain smaller wax particle sizes. In an embodiment, the mixing is performed with an apparatus suitable for the purpose. In an embodiment, the apparatus suitable for purpose comprise a batch mixer or inline mixer, low-shear or high-shear mixer, static inline mixer, agitator, disperser, grinder, shredder, comminutor, homogenizer, rotor-stator mixer or grinder such as Ultra-Turrax, Silverson high-shear inline or batch mixer, Masuko Supermass collider from Masuko Sangyo, rotor-rotor mixers or grinders such as Atrex-type devices, high-shear homogenizer such as Ariete-type or Panda-type from GEA Niro-Soavi, fluidizer, micro- or macrofluidizer such as microfluidizer from Microfluidics and/or ultrasonic disintegrator, or any combination thereof. In an embodiment, the particle size of the wax particles in the composition can be also adjusted by the quantity of the surfactant.

In an embodiment, the composition of the dispersion of the wax particles has a Brookfield viscosity of 10-6000 cP determined for aqueous 20 wt-% dry matter of the composition, 50 rpm, spindle V-73.

In an embodiment, the composition comprises a fibrillated cellulose component. The fibrillated cellulose component is a suspension comprising fibrillated cellulose and water, i.e. the fibrillated cellulose can provide the aqueous medium present in the composition. In an embodiment the fibrillated cellulose component comprises cellulose microfibrils, cellulose microfibril aggregates, and/or cellulose microfibril bundles. The fibrillated cellulose may be in a form of expanded fibrillar network, where individual microfibrils or microfibril bundles are still partially bound or entangled to each other, even after they have been subjected to homogenization. Such partially bound or entangled individual microfibrils and/or microfibril bundles may be referred to as cellulose microfibril aggregates. In an embodiment, the fibrillated cellulose component comprises entangled cellulose microfibril aggregates comprising microfibrils and/or microfibril bundles. The entangled cellulose microfibril aggregates are smaller than 200 μm.

In an embodiment, the fibrillated cellulose component is or it comprises microfibrillated cellulose (MFC). In the context of the present invention, the term “microfibrillated” may also comprise nanofibrillated cellulose fibres or fibre fragments (NFC). The fibrillated cellulose may be isolated from various cellulose raw materials. In an embodiment, the fibrillated cellulose is originated from non-wood based cellulose raw materials. In an embodiment, the fibrillated cellulose component is parenchymal cellulose. In an embodiment, the raw material of the fibrillated cellulose component is selected from sugar beet pulp, dry sugar beet pulp, wet sugar beet pulp, sugar beet pellet, potato pulp, sweet potato, cassava pulp, bagasse pith, citrus peel, corn, fruits, vegetables, soya, and any combination thereof. In an embodiment, the fibrillated cellulose component is manufactured in accordance with the method presented in WO 2022/003252 A1 publication Examples, especially in the Examples 1 and 3, or the method presented in WO 2017/103329 A1 publication Examples, especially in the Examples B and C. In an embodiment the fibrillated cellulose is obtained by mechanical treatment, such as homogenization or refining or grinding, without preceding treatment steps of the cellulose raw material selected from enzymatic modification, chemical modification, or physical modification of the raw material.

In an embodiment, the fibrillated cellulose may contain other polysaccharides, such as pectin, hemicellulose, and/or other soluble polysaccharides present in the cellulose raw material from which the fibrillated cellulose is manufactured. The amount of the other polysaccharides depends on the raw material used and on the separation method.

In an embodiment, the aspect ratio of the cellulose microfibrils is high. In an embodiment, the length of the microfibrils may be more than one micrometer and the number-average diameter is typically less than 200 nm, such as between 2 and 100 nm. The diameter of microfibril bundles may be greater, but it is usually less than 1 μm. The smallest microfibrils are similar to the so-called elementary fibrils, the diameter of which is typically 2 to 12 nm.

In an embodiment, the fibrillated cellulose component has a Schopper-Riegler value as determined by EN ISO 5267-1 (1996) below 20, preferably between 1 and 10, more preferably between 4 and 6.

There are several benefits in utilizing the fibrillated cellulose in the composition. Some of the benefits are related to the obtained product itself, but some are related to the production process of the composition. The fibrillated cellulose lowers the viscosity of the intermediate phase of the emulsion inversion point. Without utilizing fibrillated cellulose in the emulsion preparation, the viscosity during the phase inversion may increase in such extent that mechanical mixing becomes difficult.

With respect to the benefits of the fibrillated cellulose to the product, the fibrillated cellulose stabilizes the composition by contributing to a smaller wax particle size by inhibiting coalescence during aging. Thus, the fibrillated cellulose reduces ripening in the dispersion. The fibrillated cellulose component stabilizes the dispersion.

The stabilization of the micro sized wax particles and nano sized wax particles can be achieved with for instance amphiphilic surfactants or solid particles. The fibrillated cellulose component stabilizes the composition with its three-dimensional fibril network and interfacial energy. The particle size of the wax particles, the surface properties and the liquid-liquid interfacial tension of the fibrillated cellulose component contribute to the interfacial energy. The fibrillated cellulose component's three-dimensional fibril network prevents coalescence or the micro- and nano sized droplets and stabilizes the interfaces between the plant-based wax and the aqueous medium.

The particle-particle interactions of the fibrillated cellulose component affect the stability of the composition. The higher number of interactions leads to a mechanical barrier at the particle interfaces, which increases the stability of the composition. The composition during the production process stabilized by fibrillated cellulose component can be considered a Pickering emulsion, where the stabilization is characterized by interfacial energy and stabilization of emulsion by fibril network. In an embodiment, the hemicelluloses comprised by the fibrillated cellulose component contribute to the stabilization of the composition. In another embodiment, the stabilization may be provided via the combination of microfibrillated cellulose and a suitable polymer. In this particular embodiment, the stabilization is achieved through steric stabilization.

Additionally, the fibrillated cellulose acts as an adhesion promoter in the composition. For instance, if the composition is used to coat a substrate, the fibrillated cellulose increases the adhesion between the composition and the substrate, and binds the wax particle on the surface upon drying. Thus, the resulting coating is more durable.

The fibrillated cellulose component acts also as a retention agent in the composition. The fibrillated cellulose improves the retention of wax dispersion in sizing of cellulose fiber-based materials by bonding the dispersed wax particles on cellulose pulp fibers when applied in wet state prior to filtering.

In an embodiment, the composition further comprises an additional amount of microfibrillated cellulose. The additional microfibrillated cellulose increases the oleophobicity of the composition.

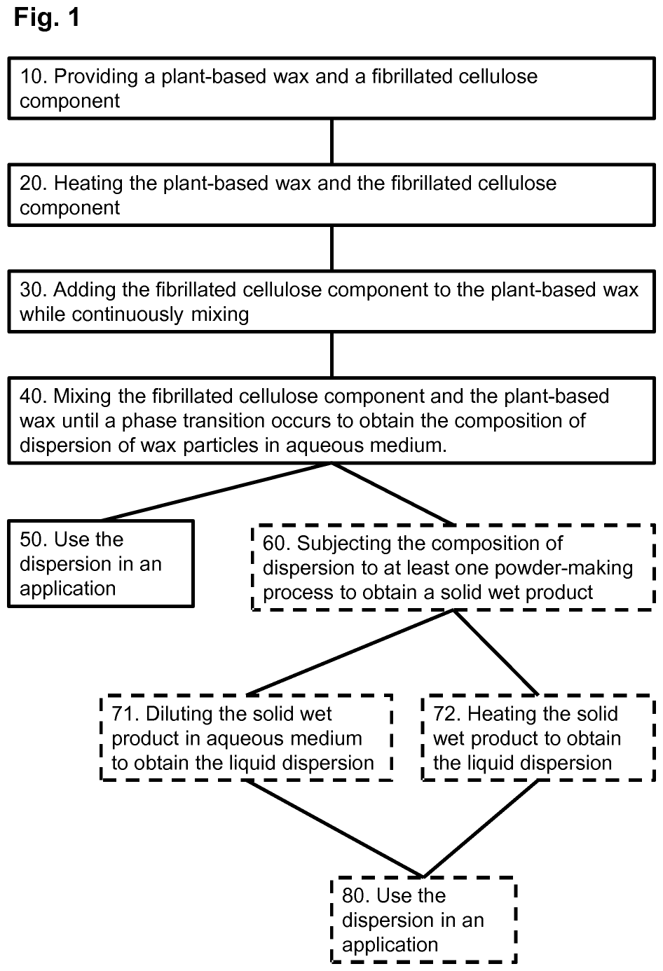

FIG. 1 schematically shows a flow diagram comprising the process steps of the method for producing the composition. The composition of the present invention comprises a plant-based wax and a fibrillated cellulose component. The step 10 shows that a plant-based wax and a fibrillated cellulose component are provided. Both are described more in detail in the foregoing description. In the step 20, both the plant-based wax and the fibrillated cellulose components are heated. The plant-based wax is heated above its melting temperature. In the step 30, the fibrillated cellulose component is added to the plant-based wax while continuously stirring. In the step 30, the fibrillated cellulose component may be added to the plant-based wax quickly or slowly. In an embodiment, the fibrillated cellulose component is added to the plant-based wax in a continuous manner. In an embodiment, the fibrillated cellulose component is added to the plant-based wax in a gradual manner. In an embodiment, the fibrillated cellulose component is added to the plant-based wax all at once. In the step 30, the composition is in a form of a water-in-oil emulsion.

In FIG. 1 in the step 40, the fibrillated cellulose component and the plant-based wax are mixed until a phase transition occurs. When the phase transition has occurred, the composition of dispersion of wax particles in aqueous medium is obtained. In an embodiment, the composition is produced by Emulsion Inversion Point (EIP) method. In the step 40, the phase transition between water-in-oil emulsion and oil-in-water emulsion occurs in the Emulsion Inversion Point. In the Emulsion Inversion Point method, the water-in-oil emulsion obtained when adding the fibrillated cellulose component to the plant-based wax converts through a phase transition to an oil-in-water emulsion through the process of interconversion at the Emulsion Inversion Point. After the step 40, the composition is in a form of a dispersion. The dispersion is a liquid in this point at room temperature. The dispersion can be used in any suitable application after the step 40, which is indicated in the step 50 of the flow diagram.

In FIG. 1, in the step 60 an alternative to using the dispersion is presented. In an alternative embodiment, the method further comprises subjecting the dispersion to a powder-making process to obtain a solid wet product. The solid wet product is obtained for instance to ease handling during storage and shipment. The solid wet product is easier to pack, to store, to ship, to transport and to handle than a liquid dispersion. The solid wet product comprises water, thus it is not waterless. After the step 60, the solid wet product may be in a form of a solid wet powder, a solid wet pellet, solid wet granulate, a solid wet cake, or any combination thereof. The mentioned powder-making process is granulation, grinding, pelleting, cubing, or any suitable technique to reduce the particle size. In an optional embodiment, the composition is subjected to drying. In an embodiment, the said optional drying is selected from the group consisting of freeze drying, lyophilization, vacuum drying, air drying, spray drying, atomization, evaporation, tray drying, flash drying, drum drying, fluid-bed drying, oven drying, belt drying, microwave drying, solar drying, or combinations thereof.

After the step 60, the solid wet product may be either diluted in an aqueous medium according to step 71, or heated according to step 72, to obtain a liquid dispersion. Thus, in an embodiment, the solid wet product is re-dispersible. A re-dispersible solid wet product can be processed back into a dispersion. In the step 80, the re-dispersed liquid dispersion is used in any suitable application. The obtaining the solid wet product and re-dispersing the solid wet product back to a liquid form may be performed multiple times, and it is not limited to one cycle.

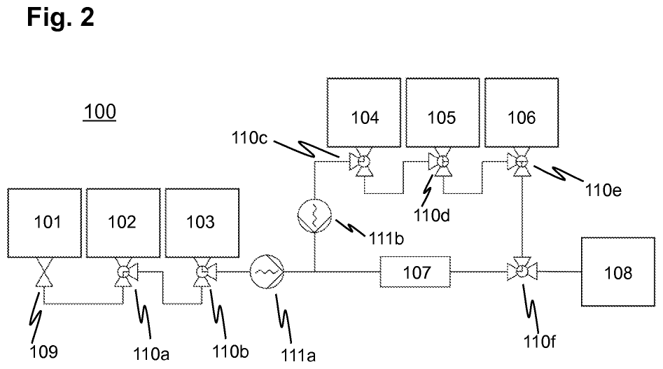

FIG. 2 schematically shows a process configuration 100 for producing a microfibrillated cellulose (MFC) stabilized wax dispersion according to an example embodiment.

In the FIG. 2, the tank 101 comprises a solution comprising multivalent cations, such as Ca²⁺. The tank 102 comprises water. The tank 103 comprises the fibrillated cellulose component, preferably a microfibrillated cellulose component, which is heated to an elevated temperature, such as 80° C. The tank 104 comprises the plant-based wax, which is heated to an elevated temperature, such as 90° C. In the tank 104, the wax is saponified, for instance with potassium hydroxide.

The mixing in the process configuration 100 may be performed by individual mixers located in the tanks. For instance, the tanks 105, 106 and 108 may be equipped with individual mixers. Alternatively, the mixing in the process configuration 100 may be performed via in-line mixer 107 in between the tanks. The material from any one of the tanks may be guided through the in-line mixer 107, to enhance the agitation.

In the tank 105, the saponified oil from tank 104 is mixed with the fibrillated cellulose component from tank 103. In this step, the mixing can be adjusted to gain a desired wax particle size. In the tank 106, the mixture of heated wax and the heated fibrillated cellulose component is mixed with water from tank 102. In the tank 108, the mixture from tank 106 comprising heated wax, the heated fibrillated cellulose and water is mixed with the solution comprising divalent cations, such as Ca²⁺ from tank 101. The product is stored and cooled in the tank 108.

In an embodiment, the equipment used to prepare compositions be capable of effecting agitation of the reactants to achieve thorough mixing and have proper temperature controls to maintain adequate heating and cooling of the reagents and the products.

In the FIG. 2, valves 110 (110a, 110b, 110c, 110d, 110e, 110f) control the flow between the tanks. Preferably, the valves 110 are three-way-valves. In an embodiment, the valves may be individually controllable. Pumps 111 (111a, 111b) pump the process materials to desired tanks. The process configuration 100 enables a continuous process configuration. The tanks 105, 106 and 107 may be connected in series, either directly or with buffer tanks (not shown). By adding pumps and inline mixers, these process steps may be run simultaneously.

Optionally, the valves 110 and pumps 111 enable by-passing. Thus, whenever necessary, any of the previously mentioned tanks can be by-passed and certain process steps skipped. Additionally, the valves 110 and pumps 111 enable certain components of the composition to be left out completely.

In an embodiment the process steps are carried out in the sequence identified in any aspect, embodiment, or claim. In another embodiment any process step specified to be carried out to a product or an intermediate obtained in a preceding process step is carried out directly to said product or intermediate, i.e. without additional, optional or auxiliary processing steps that may chemically and/or physically alter the product or intermediate between said two consecutive steps.

A coating formulation comprising the aforementioned composition is provided. In an embodiment, the composition is used as an ingredient of a coating formulation. In an embodiment, the formulation further comprises hot or cold soluble starches, other viscosity modifiers, pigments or fillers such as clay, titanium dioxide, kaolinite, calcium carbonate, bentonite, talc, or any combination thereof. In an embodiment, the formulation may further comprise an anti-foaming agent, a pH adjusting agent, or any combination thereof.

In an embodiment, the composition is used as an ingredient in a coating or adhesive formulation. In an embodiment, the said coating or adhesive formulation further comprises at least one thermoplastic polymer in dissolved or latex form. In an embodiment, the said coating or adhesive formulation forms a heat-sealable layer after drying.

In an embodiment, the composition is used in paper or board coating process, such as in spray coating, blade coating, bar coating, film coating, or curtain coating.

In an embodiment, the composition is used as a coating of fruits, berries, vegetables, or other edible substances to form an edible coating. The said edible coating protects the product and prevents drying upon storage.

In an embodiment, the composition is used as a coating or ingredient of various feed formulations such as feed pellets or granulated functional components such as vitamins. The composition is used in the said applications to protect the materials from exposure of water, oil, or oxygen. The composition can be applied on pellets, granules or similar by conventional coating methods. The usage of the composition prevents drying upon storage.

An article of manufacture is provided which comprises the present composition. In an embodiment, the article comprises a cellulosic medium, such as paper, board, wood, pulp or starch-based medium. The article comprises at least one layer of coating of the composition of the first aspect comprising plant-based wax and a fibrillated cellulose component. The usage of the composition improves the properties of the article, such as barrier properties, moisture- and water resistance, hydrophobicity, oleophobicity, durability, printing properties and inhibiting water absorption.

In an embodiment, coating and sub-sequent drying of the article with the composition of the first aspect is conducted at a temperature lower than the melting point of the wax. In an embodiment, coating and/or sub-sequent drying of the article with the composition of the first aspect is conducted at a temperature higher than the melting point of the wax.

In an embodiment, the article may be for single use product, such as a food serving or packaging article, or for continuous use product. In an embodiment, the article of manufacture is biodegradable.

In an embodiment the present process is an industrial process. In another embodiment the industrial process may exclude small scale methods such as laboratory scale methods that are not scaled up to volumes used in industry.

In an embodiment the present method is a continuous method. In another embodiment, the present method is a semi-continuous method. According to an embodiment, the present method comprises batch process steps.

In another aspect is provided a method for manufacturing a dispersion comprising:
Blending hydrogenated tall oil and hydrogenated plant oil, preferably rapeseed oil, by mixing and heating to provide liquefied wax blend;
Providing a MFC (microfibrillated cellulose) dispersion in water;
Making an emulsion by pouring the MFC dispersion in water into the wax blend with high-shear mixing;
Diluting the emulsion into cold water-based solution containing polyvinyl alcohol; and
Optionally adding CaCl2 and high shear mixing.

The obtained dispersion can be used as hydrophobic coating.

In another aspect is provided a method for manufacturing a dispersion comprising:
Providing hydrogenated melted plant wax, preferably rapeseed wax;
Providing a MFC dispersion in water;
Providing a water-based solution containing polyvinyl alcohol;
Blending with high-shear mixing the hydrogenated melted plant wax and the water based solution containing polyvinyl alcohol to obtain a wax dispersion;
Diluting the wax dispersion with cold water with high shear mixing; and
Mixing with high-shear mixing the wax dispersion and the MFC dispersion in water.

The dispersion has good water barrier and oil barrier properties.

In another aspect is provided a method for manufacturing a dispersion comprising:
Providing hydrogenated melted plant wax, preferably rapeseed wax;
Providing a water-based solution containing polyvinyl alcohol and MFC;
Making an emulsion by pouring the water-based solution containing polyvinyl alcohol and MFC to the hydrogenated melted plant wax and mixing by using high-shear mixing;
Diluting the emulsion by cold water containing polyvinyl alcohol, and mixing by high shear mixing to provide a wax dispersion.

The obtained wax dispersion has good water and oil barrier properties.

Implementation and embodiments are further disclosed in the following numbered clauses:
Clause 1. A composition comprising: a plant-based wax; a fibrillated cellulose component; and wherein the composition is a dispersion of wax particles in an aqueous medium.
Clause 2. The composition of clause 1, wherein the fibrillated cellulose comprises entangled cellulose microfibril aggregates comprising microfibrils and/or microfibril bundles which are smaller than 200 μm.
Clause 3. The composition of clause 1 or 2, wherein the plant-based wax comprises triglycerides and/or partially saponified triglyceride, and the plant-based wax is preferably selected from the group consisting of palm wax, palm kernel wax, rapeseed wax, soy wax, corn wax, canola wax, carnauba wax, candelilla wax, ourieury wax, soybean wax, coconut wax, cranbe wax, sunflower wax, linseed wax, cottonseed wax, sugar cane wax, bayberry wax, peanut wax or a combination thereof.
Clause 4. The composition of any one of the clauses 1-3, wherein the fibrillated cellulose component is fibrillated parenchymal cellulose.
Clause 5. The composition of any one of the clauses 1-4, wherein the fibrillated cellulose component comprises celluloses in an amount of less than 70 wt-% dry matter of the fibrillated cellulose component, and hemicelluloses in an amount of more than 30 wt-% dry matter of the fibrillated cellulose component.
Clause 6. The composition of any one of the clauses 1-5, wherein the composition further comprises multivalent cations, preferably Zn²⁺, Mg2+, Cu2+, Fe2+, Fe3+, Al3+, Sn2+, or Ca2+, or a fatty acid salt of the multivalent cation.
Clause 7. The composition of any one of the clauses 1-6, wherein the composition comprises wax particle sizes of less than 20 μm, preferably between 0.1-10 μm, most preferably between 0.5-8 μm.
Clause 8. The composition of any one of the clauses 1-7, wherein the plant-based wax is hydrogenated, or partially hydrogenated.
Clause 9. The composition of any one of the clauses 1-8, wherein the dispersion of the wax particles has a Brookfield viscosity of 10 cP-6000 cP determined for aqueous 20 wt-% dry matter of the composition, 50 rpm, spindle V-73.
Clause 10. A solid wet product obtained by subjecting the composition of any one of the clauses 1-9 to a powder-making process.
Clause 11. A method for producing the composition of any one of the clauses 1-9, comprising: providing a plant-based wax; providing a fibrillated cellulose component; heating the plant-based wax and the fibrillated cellulose component; adding the fibrillated cellulose component to the plant-based wax while continuously mixing; mixing the fibrillated cellulose component and the plant-based wax until a phase transition occurs to obtain the composition of dispersion of wax particles in an aqueous medium.
Clause 12. The method of clause 11, wherein the method is performed with the Emulsion Inversion Point method.
Clause 13. A method for producing a liquid dispersion comprising: providing the solid wet product of clause 10; diluting the solid wet product in aqueous medium, or heating the solid wet product, to obtain the liquid dispersion.
Clause 14. A coating formulation comprising the composition of any one of the clauses 1-9.
Clause 15. An article of manufacture, wherein the article comprises a cellulosic medium, and wherein the article comprises at least one layer of coating of the composition of any one of the clauses 1-9.
Clause 16. Use of the composition of any one of the clauses 1-9 in sizing, internal sizing, paper coating, board coating, barrier coating, hydrophobic coating, oleophobic coating, corrugated board production, gypsum board production, wood panel production, hard- or soft board production, laminated veneer lumber production, and/or chip board production.

### EXAMPLES

The following examples are provided to better illustrate the claimed invention. They are not to be interpreted as limiting the scope of the invention, which is determined by the claims. To the extent that specific materials are mentioned, it is merely for purposes of illustration which not intended to limit the invention. One skilled in the art may use or develop equivalent means or materials without exercising inventive capacity and without departing from the scope of the invention. It shall be understood that many variations can be made in the procedures described herein while remaining within the scope of the present invention. All exemplary materials and parameters used in the examples below are compatible with the method and products specified in the independent claims. Any non-essential feature disclosed in the examples or embodiments herein can be included in a method or product of an independent claim without adding new matter.

In the context of the present invention, the composition is an emulsion during the production of it, whereas the final product is a dispersion.

### Example 1

The process for preparing a composition comprising hydrogenated rapeseed wax and a sugar beet microfibrillated cellulose (MFC), is given below. The sugar beet microfibrillated cellulose (MFC) is manufactured in accordance with the method presented in WO 2022/003252 A1 publication Examples, especially in the Example 3, sample 3C.

With reference to the Tables 1a and 1b, entry A: Hydrogenated rapeseed wax, having a melting point of 68° C. and a theoretical triglyceride composition of 90% Stearic acid, 7% Palmitic acid was used to produce dispersions by adding the MFC containing water phase (preheated to 80° C.) to the molten wax phase at once or at a rate of 50 g/ml while stirring. Foaming was avoided by adjusting the stirrer to avoid whipping of air into the system. Surfactant was generated in situ in the oil phase by saponification by potassium hydroxide.

With reference to the Tables 1a and 1b, entry B: The wax (300 g) was weighed in a 1 L glass beaker and allowed to melt at 100° C. To the liquified wax, 6.0 g of potassium hydroxide, KOH, (50%) solution was added and allowed to stir for 60 minutes at 90° C. On a separate beaker, a 1.5% Sugar Beet MFC dispersion (173 g) was heated to 80° C. and pH adjusted to 11. The emulsion was produced by pouring the MFC containing water phase to the wax at a once and mixed using a high-shear blender (17000 rpm, 180 W) for 30 seconds. The obtained emulsion was diluted with water (20° C.) to obtain the composition shown in Tables 1a and 1b.

With respect to the Tables 1a and 1b, entry C: The wax (381 g) was weighed in a glass beaker and allowed to melt at 100° C. To the liquified wax, 30.5 g of KOH (50%) solution was added and allowed to stir for 90 minutes at 90° C. On a separate beaker, a 3% Sugar Beet MFC dispersion (255 g) was heated to 80° C. The emulsion was produced by pouring the water phase to the oil phase at a rate of around 50 g/minutes while stirring with a propeller mixer at 500 rpm and allowed to mix for 5 minutes. 381 g of water (20° C.) was added and allowed to mix. The dispersion was further diluted with a solution of CaCl₂ (7.15 g, 77%) dissolved in 990 g of water and mixed with high-shear blender (17000 rpm, 180 W) to obtain the composition shown in Tables 1a and 1b. A reference sample without sugar beet MFC was done as above, (Tables 1a and 1b, Entry A), using however high shear blending due to extremely high viscosity of the emulsion inversion point.

The examples show that using Sugar Beet MFC during emulsification reduces the wax particle size. The viscosity around the emulsion inversion point is also reduced. The obtained dispersion has hydrophobic properties, and in the presence of multivalent salts, also oleophobic properties can be obtained.

TABLE 1a
Dispersions obtained from hydrogenated rapeseed wax.

| | Emulsification | MFC/ | KOH/ | CaCl₂/ | | | |
|---|---|---|---|---|---|---|---|
| Entry | method | Wax | Wax | Wax | MFC | Wax | CaCl₂ |
| A | Water, High-shear | — | 0.04 | — | — | 19.29% | — |
| | mixing | | | | | | |
| B | MFC, High shear- | 0.009 | 0.01 | — | 0.17% | 19.88% | — |
| | mixing | | | | | | |
| C | MFC, propeller, | 0.02 | 0.04 | 0.014 | 0.37% | 18.65% | 0.27% |
| | dilution with CaCl₂ | | | | | | |

TABLE 1b
Dispersions obtained from hydrogenated rapeseed wax.

| | Particle size | | | Viscosity after |
|---|---|---|---|---|
| Entry | (max) μm | Hydrophobic | Oleophobic | 2 weeks |
| A | 65 | — | — | >10 000 |
| B | 10 | YES | NO | 5100 |
| C | 8 | YES | YES | 4400 |

### Example 2

The process for preparing a composition comprising hydrogenated palm wax and a sugar beet microfibrillated cellulose (MFC), is given below. The sugar beet microfibrillated cellulose (MFC) is manufactured in accordance with the method presented in WO 2022/003252 A1 publication Examples, especially in the Example 3, sample 3C

Hydrogenated palm wax, having a melting point of 58° C. and a theoretical triglyceride composition of 54% Stearic acid, 43% was used to produce dispersions.

With respect to the Tables 2a and 2b, entry A: The wax (400 g) was weighed in a glass beaker and allowed to melt at 100° C. To the liquified wax, 32 g of KOH (50%) solution was added and allowed to stir for 60 minutes at 90° C. On a separate beaker, a 3% Sugar Beet MFC dispersion (233 g) was heated to 80° C. The emulsion was produced by pouring the water phase to the oil phase at a rate of around 50 g/minutes while stirring with a propeller mixer at 500 rpm and allowed to mix for 5 minutes. 405 g of water (20° C.) was added and allowed to mix. 400 g of the obtained dispersion was taken and diluted with a solution of CaCl₂ (2.8 g, 77%) dissolved in 400 g of water and mixed with high-shear blender (17000 rpm, 180 W) to obtain the composition shown in Tables 2a and 2b.

With respect to the Tables 2a and 2b, entry B: The wax (300 g) was weighed in a glass beaker and allowed to melt at 100° C. To the liquified wax, 24.0 g of KOH (50%) solution was added and allowed to stir for 60 minutes at 90° C. On a separate beaker, a 3% Sugar Beet MFC dispersion (173 g) was heated to 80° C. The emulsion was produced by pouring the water phase to the oil phase at a once and mixed with a propeller mixer at 500 rpm and allowed to mix for 5 minutes. 300 g of water (20° C.) was then added and allowed to mix. The pH of the resulting dispersion was then adjusted to 11 with KOH. 457 g of the obtained dispersion was taken and diluted with a solution of Sodium dodecyl sulfate (SDS) (4.0 g, 99%) dissolved in 280 g of water and mixed with high-shear blender (17000 rpm, 180 W) to obtain the composition shown in Tables 2a and 2b.

The examples show that palm oil wax can be used instead of rapeseed oil wax with similar results. The obtained dispersion has hydrophobic properties, and in the presence of multivalent salts, also oleophobic properties can be obtained. If desired, the viscosity of dispersions can be reduced using an additional surfactant, such as sodium dodecyl sulfate (SDS).

TABLE 2a
Dispersions obtained from hydrogenated palm oil wax.

| | Emulsification | MFC/ | KOH/ | CaCl₂/ | | | | |
|---|---|---|---|---|---|---|---|---|
| Entry | method | Wax | Wax | Wax | MFC | Wax | CaCl₂ | SDS |
| A | MFC, propeller, | 0.017 | 0.04 | 0.014 | 0.33% | 18.64% | 0.27% | — |
| | Dilution with CaCl₂ | | | | | | | |
| B | MFC, propeller, | 0.017 | 0.04 | 0.014 | 0.40% | 23.18% | — | 0.54% |
| | Dilution with SDS | | | | | | | |

TABLE 2b
Dispersions obtained from hydrogenated palm oil wax.

| | Particle size | | | Viscosity after |
|---|---|---|---|---|
| Entry | (max) μm | Hydrophobic | Oleophobic | 2 weeks |
| A | 10 | YES | YES | 2800 |
| B | 10 | YES | YES | 2030 |

### Example 3

An example of the induced solidification of wax dispersions comprising hydrogenated palm oil and sugar beet microfibrillated cellulose (MFC) to obtain a solid wet product, is given below. The sugar beet microfibrillated cellulose (MFC) is manufactured in accordance with the method presented in WO 2022/003252 A1 publication Examples, especially in the Example 3, sample 3C

With respect to the Tables 3a and 3b, entry A: Hydrogenated palm oil wax (400 g) was weighed in a glass beaker and allowed to melt at 100° C. To the liquified wax, 16.0 g of KOH (50%) solution was added and allowed to stir for 60 minutes at 90° C. On a separate beaker, a 3% Sugar Beet MFC dispersion (230 g) was heated to 80° C. The emulsion was produced by pouring the MFC containing water phase to the wax at a once and mixed using a high-shear blender (17000 rpm, 180 W) for 30 seconds. 305 g of water was then added to the dispersion and mixing was continued with high-shear blender (17000 rpm, 180 W) for 60 seconds, by which time a low viscosity dispersion was obtained. The dispersion was cooled in a water batch to 20° C. and allowed to solidify to obtain the composition shown in Tables 3a and 3b. The solid wet wax could easily be made to free-flowing non-sticky powder.

With respect to the Tables 3a and 3b, entry B: Hydrogenated palm oil wax (400 g) was weighed in a glass beaker and allowed to melt at 100° C. To the liquified wax, 32.0 g of KOH (50%) solution was added and allowed to stir for 60 minutes at 90° C. On a separate beaker, a 4% Sugar Beet MFC dispersion (230 g) was heated to 80° C. The emulsion was produced by pouring the MFC containing water phase to the wax at a once and mixed using a high-shear blender (17000 rpm, 180 W) for 30 seconds. A solution of CaCl₂ (7.5 g 77%) in 336 g of water was then added to the dispersion and mixing was continued with high-shear blender (17000 rpm, 180 W) for 60 seconds, by which time a low viscosity dispersion was obtained. The dispersion was cooled in a water batch to 20° C. and allowed to solidify to obtain the composition shown in Tables 3a and 3b. The solidified hard wet wax could easily be made to free-flowing non-sticky powder.

The examples show that the dispersions can be formulated to solidify rapidly, by adjusting the wax particle size, the surfactant, and the amount of MFC. Further, the particle size of the wax particles can be adjusted by the surfactant (saponification ratio) and the method of mixing during emulsification. The dispersion has hydrophobic properties, and in the presence of multivalent salts, also oleophobic properties can be obtained.

TABLE 3a
Solidified dispersions obtained from hydrogenated palm oil wax.

| | Emulsification | MFC/ | KOH/ | CaCl₂/ | | | |
|---|---|---|---|---|---|---|---|
| Entry | method | Wax | Wax | Wax | MFC | Wax | CaCl₂ |
| A | MFC, High shear | 0.017 | 0.02 | — | 0.73% | 42.07% | — |
| | mixing | | | | | | |
| B | MFC, High shear | 0.023 | 0.04 | 0.014 | 0.91% | 39.78% | 0.57% |
| | mixing | | | | | | |

TABLE 3b
Solidified dispersions obtained from hydrogenated palm oil wax.

| | Particle size | | | Solidification |
|---|---|---|---|---|
| Entry | (max) μm | Hydrophobic | Oleophobic | time |
| A | 2.5 | YES | NO | 10 min |
| B | 2.5 | YES | YES | 30 min |

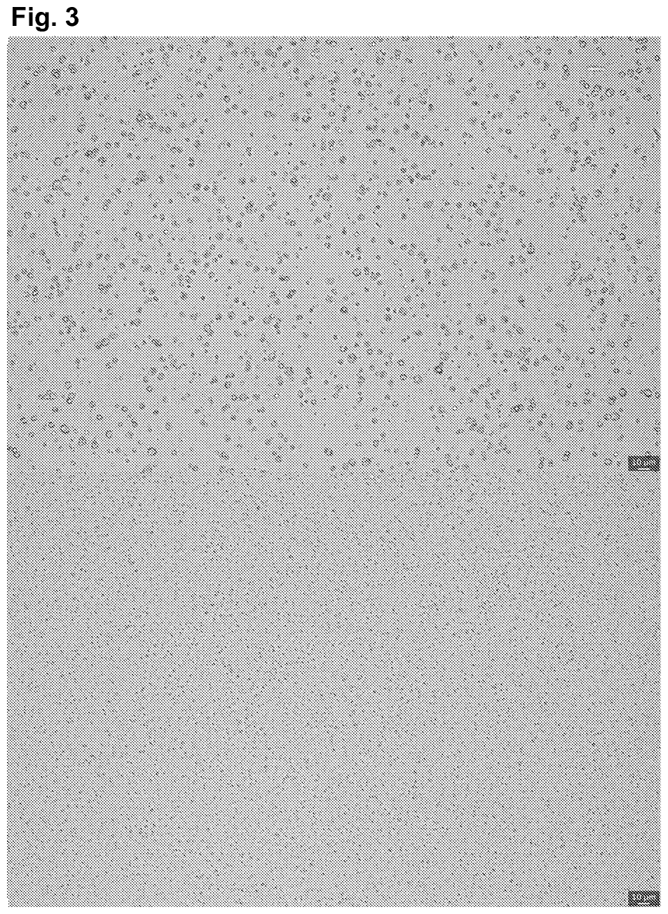

The FIG. 3 presents optical microscopy images with 40× magnification of obtained wax dispersions produced with MFC. The upper image in the FIG. 3 presents the low-shear mixing obtained from Example 1, entry C. The bottom image in the FIG. 3 presents the high shear mixing dispersion from the Example 3, entry B. The scale bar in the FIG. 3 is 10 μm.

### Example 4

The storage and re-dispersing a powder-like solid wet product by heating is presented below.

The solidified wax dispersion from Example 3, Entry A, which was crumbled to a free-flowing powder form, was stored for 1 month, after which it was heated at 80° C. water bath, turning the material back to a low viscosity liquid dispersion having the original properties as before solidification.

The example shows that a powder-like wet dispersion has long shelf life and can be transformed to liquid form simply by heating. Further, a powder-like material can be beneficial for transporting and storing in bags.

### Example 5

The storage and re-dispersing a powder-like solid wet product by diluting is presented below.

Solidified wax dispersion from Example 3, Entry A, which was crumbled to a free-flowing powder form, was stored for 1 month, after which it was diluted to 20 wt-% and dispersed using a high-shear blender (17000 rpm, 180 W) for 60 seconds turning the material back to a low viscosity liquid dispersion having the original properties as before solidification.

The example shows that a powder-like wet dispersion has long shelf life and can be made in liquid dispersion form by dilution. Further, a powder-like material can be beneficial for transporting and storing in bags.

### Example 6

Several methods of analysis of the wax dispersions are presented below.

The viscosity of samples was measured by Brookfield DV3T viscometer (RV-torque range, Brookfield Engineering Laboratories, Middleboro, USA) equipped with a vane geometry (V-73). The formulated samples were measured at 50 rpm shear rate.

The pH of samples was measured using a Hach Pocket Pro plus pH-meter. Optical microscopy images were obtained by Nikon Eclipse E200 microscope equipped with a Canon EOS 100D camera, using 10× and 40× magnifications and cross-polarization.

The hydrophobic/oleophobic properties were determined from dispersion coated boxboard (Rochcoat GC2) by placing a drop of rapeseed oil or water and observing stability after 30 minutes.

### Example 7

The coating test for the composition according to the present invention to laminated veneer lumber, is presented below.

Laminated veneer lumber (LVL) hydrophobization was conducted by applying wax dispersion according to the dispersion presented Example 1C on the cross-section cut of the laminated veneer lumber. The dispersion was allowed to dry at room temperature. The dry coating was tested as is (A) and polished by cloth (B). A drop of water was placed on top of the coating. The water drop did not penetrate the wood, but rather evaporated during several hours. The reference untreated LVL cross-section cut absorbed water in seconds.

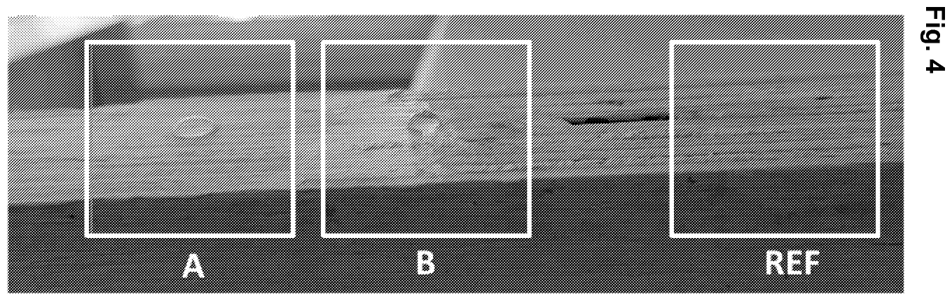

FIG. 4 presents the results of the coating test made with wax dispersion on cut side of laminated veneer lumber. In the FIG. 4 the water droplets are on A) coated layer B) coated, polished layer, and REF) not coated veneer lumber. The example shows that the developed wax can be used to hydrophobize wood and the surface texture can be readily polished.

### Example 8

The coating of paper with the composition according to the present invention is presented below.

Dispersion coating of a paper substrate was demonstrated with Elcometer 4340 draw down coater using two different wax dispersion. The paper substrate, the base paper, was UPM Fine un-coated woodfree paper at 300 g/m² basic weight. Process details are summarized in Table 4.

The coating dispersion was prepared from the wax dispersions described in Example 1, entry C or Example 2, entry A by diluting the corresponding dispersion to 15 wt-% dry matter content aqueous dispersion. The coating dispersion was easy to apply with the coater and smooth coated layers were obtained. The coated substrates were dried at temperatures below the melting point of the wax (66 C° or 56 C°) or at higher temperature, well above the melting points (80 C°). Two different coat weight level was targeted in the experiment, either 10-11 g/m² or 5-7 g/m².

The coating conditions for the coating experiment shown in Table 4 are temperature of 23° C. and normal room humidity. The test conditions for the experiments shown in Table 4 are temperature of 23° C. and humidity 50% RH. The grammage was measured according to ISO 536:19 (2019).

TABLE 4
Details of the coating experiment.

| | | | Drying | Drying | | Rod | Rod | Grammage | after | Calculated |
|---|---|---|---|---|---|---|---|---|---|---|
| Test | | Target coat | time, | temp., | Rod(s) | speed, | pressure, | base, | coating, | actual coat |
| points | Coat | weight, g/m² | min | ° C. | used | mm/s | g | g/m² | g/m² | weight, g/m² |
| KP1 | Example 1, | 11 | 15 | 66 | 10 | 50 | 1500 | 279 | 289.5 | 10.5 |
| | entry C | | | | | | | | | |
| KP2 | Example 1, | 11 | 10 | 80 | 20 | 50 | 1500 | 281 | 291.5 | 10.5 |
| | entry C | | | | | | | | | |
| KP3 | Example 1, | 6 | 15 | 66 | smooth | 50 | 2000 | 282 | 288 | 6 |
| | entry C | | | | | | | | | |
| KP4 | Example 1, | 6 | 10 | 80 | 10 | 50 | 2000 | 280 | 287 | 7 |
| | entry C | | | | | | | | | |
| KP5 | Example 2, | 11 | 20 | 56 | 20 | 50 | 2000 | 284 | 294.5 | 10.5 |
| | entry A | | | | | | | | | |
| KP6 | Example 2, | 11 | 10 | 80 | 30 | 50 | 1000 | 285 | 295 | 10 |
| | entry A | | | | | | | | | |
| KP7 | Example 2, | 6 | 20 | 56 | 10 | 50 | 2000 | 282 | 288 | 6 |
| | entry A | | | | | | | | | |
| KP8 | Example 2, | 6 | 10 | 80 | 10 | 50 | 2000 | 283 | 288 | 5 |
| | entry A | | | | | | | | | |

### Example 9

The analysis of the coated papers from the Example 8 is presented below.

The water absorbency and surface properties of the coated papers described in Example 8 were analyzed with different methods, see Table 5. The surface energy and contact angles were measured with FIBRO ETIX. Clearly the dispersion coating with the used waxes hydrophobized the base paper and the characteristic Cobb60 value was drastically lowered for all test points. Also, the paper surface turned more hydrophobic as water contact angle increased and the surface energy increased. Conducting the drying stage at temperatures lower than the melting point of the corresponding wax seems to have a slight impact on functionality as the Cobb60 value is generally lower compared to samples that were dried at elevated temperatures (80 C°). The same tendency can be seen also with surface energy and contact angle. The results are, however, very good also for the test points where the drying temperature exceeds the melting temperature.

TABLE 5
Summary of the water absorbency and surface properties of the test points.

| | | Base | | | | | | | | |
|---|---|---|---|---|---|---|---|---|---|---|
| | Method | paper | KP1 | KP2 | KP3 | KP4 | KP5 | KP6 | KP7 | KP8 |
| Water | ISO | 65.9 | 18.9 | 20.1 | 28.4 | 34.6 | 6.6 | 20.7 | 8.9 | 26.0 |
| absorbency, | 535: | | | | | | | | | |
| Cobb60, g/m³ | 2014 | | | | | | | | | |
| St.dev., g/m³ | | 22.0 | 2.8 | 5.8 | 13.2 | 13.4 | 2.3 | 6.0 | 2.4 | 5.5 |
| Water contact | ISO/TS | 100.8 | 126.3 | 106.6 | 125.7 | 111.3 | 124.3 | 97.2 | 125.2 | 105.5 |
| angle, after | 14778: | | | | | | | | | |
| 10 sec | 2021 | | | | | | | | | |
| Surface energy | Fowkes | 51.1 | 21.8 | 28.4 | 22.7 | 25.5 | 23.9 | 28.9 | 24.3 | 27.4 |
| (mJ/m²), after | | | | | | | | | | |
| 10 sek | | | | | | | | | | |

### Example 10

The application of internal sizing using the composition according to the present invention, is presented below.

Internal sizing of cellulose pulp sheets was demonstrated with the wax dispersion described in Example 2, entry A. The cellulose sheets were made according to method ISO 5269-1:2005 by using a mixture of 70% bleached birch pulp (SR38) and 30% bleached pine pulp (SR32) and 0.01% retention agent (Fennopol K3400P). The total dosage of the wax dispersion was 1.0%, calculated as dry amounts. The wax dispersion was added together with retention aid into dilute slurry of the pulp fibers. The obtained mixture was filtered and dried according to the standard. The characteristic values for the reference and wax dispersion treated sheets are shown in Table 6.

Compared to reference sheets, the wax dispersion treated pulps sheets are showing clearly much lower water absorbency, which is shown as Cobb60-value in Table 6.

TABLE 6
Summary of the internal sizing experiment.

| | | Number | | |
|---|---|---|---|---|
| | Method | of tests | ref. | TP1 |
| Grammage, g/m² | ISO 5270: 2012 | | 150 | 149 |
| Single sheet | ISO534: 2011, | 10 | 197 | 191 |
| thickness, μm | modif. | | | |
| St. dev, μm | | | 8.1 | 6.5 |
| Apparent sheet | ISO534: 2011 | 10 | 761 | 778 |
| density, kg/m³ | | | | |
| St. dev, kg/m³ | | | 31 | 26 |
| Apparent specific | ISO534: 2011 | 10 | 1.31 | 1.28 |
| sheet volume, cm³/g | | | | |
| (Bulk) | | | | |
| St. dev, cm³/g | | | 0.05 | 0.04 |
| Water absorbency, | ISO535: 2014 | 5 | *193 | 35.6 |
| Cobb60, g/m² | | | | |
| St. dev, g/m² | | | 19.5 | 9.8 |

*The water passes through the sample.

### Example 11

The application of the composition according to the present invention in gypsum board, is presented below.

Gypsum hemihydrate, water, and wax emulsion (10% dry matter content) were mixed in different ratios, keeping gypsum to water ratio constant considering the water in the wax emulsion. Gypsum was first mixed with water, and wax emulsion was then mixed to the plaster. The Table 7 shows the compositions. 75 g samples of plaster were molded in paper cups, hardened in room conditions for 1 h, then baked at 90° C. for 2 h and finally dried at 60° C. overnight in a convection oven.

TABLE 7
The compositions.

| Wax content | Wax dispersion | | CaSO₄ | Total |
|---|---|---|---|---|
| in dry plaster | (10%) | Water | hemihydrate | wet |
| 0.0% | 0 | 40 | 60 | 100 |
| 1.0% | 7.1 | 33 | 60 | 100 |

The water absorption was tested by immersing the samples to water for 2 hours, quickly wiping the loose water from the surfaces with a tissue and measuring the mass change. With 1.0% wax addition a 20% decrease in water absorption was observed.

### Example 12

Hydrogenation of tall oil acid was done as follows: 100 g of distilled tall oil acid (Acid number (ASTM D465), 196 mg KOH/g and iodine number (ASTM D5768), 153 g (I2)/100 g) was charged in a two neck round bottom flask and 2.00 grams of catalyst (10% palladium on carbon) was added and mixed using a magnetic stirrer. The mixture was first flushed with argon and then hydrogen and the temperature was raised to 150° C. using an oil bath. The hydrogenation was allowed to proceed for 4 days at atmospheric pressure, after which the mixture was flushed with argon. The catalyst was removed by vacuum filtration of the molten mixture through 415 filter paper and then through 589/3 filter paper. The obtained hydrogenated tall oil acid (yield 90 g) had an iodine number of 54 g (I2)/100 g and a melting point of 53-55° C.

A blend of hydrogenated tall oil and hydrogenated rapeseed oil was formulated as follows: Rapeseed wax (42.7 g) and tall oil wax (2.3 g) were weighed in a glass beaker and allowed to melt at 100° C. To the liquified wax blend, 0.9 g of KOH (50%) solution was added and allowed to stir for 60 minutes at 90° C. On a separate beaker, Sugar Beet MFC dispersion (produced according to WO2022/003252, in particular Example 3, sample 3C) 1.5% (26 g) was heated to 80° C. An emulsion was produced by pouring the MFC containing water phase to the wax at a once and mixed using a high-shear blender (Ultra-Turrax 12 krpm) for 60 seconds. The obtained emulsion was diluted and cooled by pouring it in to 137 g of cold water, containing 0.13% polyvinyl alcohol (Kuraray, Poval 8-88) and allowed to stir. A solution of CaCl₂ (2.94%, 13.5 g) was then added while high shear mixing (17000 rpm, 180 W) to obtain fatty calcium salt. The obtained dispersion could be used as hydrophobic coating.

### Example 13—Addition Sequence of MFC

Hydrogenated rapeseed wax (300 g) was weighed in a glass beaker and allowed to melt at 100° C. To the liquified wax, 0.27 g of citric acid hydrate was added, following 24.0 g of KOH (50%) solution and allowed to stir for 120 minutes at 90° C. On a separate beaker, 173 g of 3% solution of polyvinyl alcohol (Poval 8-88) was heated to 80° C. The wax dispersion was produced by pouring the polymer solution to the wax at a once and mixing using a high-shear blender (Ultra-Turrax 12 krpm) for 60 seconds and further diluted with cold water (2330 g) containing 0.129% of Polyvinyl alcohol (Poval 8-88) and high shear blending (17000 rpm, 180 W) for 60 seconds. The obtained wax dispersion had a maximum particle size of 3 μm and concentration of around 11%. To 2584 g of the obtain dispersion, a solution of CaCl₂ 1.06%, 363 g was added under high-shear mixing.

To 200 g of the obtained wax dispersion, 16.2 g of 7% microfibrillated cellulose (Produced according to WO2017/103329, see in particular Example E, sample 202.2) was added and mixed with high-shear mixing to obtain a wax dispersion containing microfibrillated cellulose, having good water and oil barriers.

### Example 14—Addition Sequence of MFC

Hydrogenated rapeseed wax (300 g) was weighed in a glass beaker and allowed to melt at 100° C. To the liquified wax, 0.27 g of citric acid hydrate was added, following 24.0 g of KOH (50%) solution and allowed to stir for 120 minutes at 90° C. On a separate beaker, 173 g of 3% solution of polyvinyl alcohol (Poval 8-88) and 1% of microfibrillated cellulose (Produced according to WO2017/103329, see in particular Example E, sample 202.2) was heated to 80° C. The emulsion was produced by pouring the aqueous phase to the wax at once and mixed using a high-shear blender (17000 rpm, 180 W) for 60 seconds and further diluted with cold water (2300 g) containing 0.129% of Polyvinyl alcohol (Poval 8-88) and high shear blending (17000 rpm, 180 W) for 60 seconds to obtain a wax dispersion having a maximum particle size of 3 μm and concentration of around 11%. To 2580 g of the obtain dispersion, a solution of CaCl₂ 1.06%, 360 g was added under high-shear mixing. The obtained wax dispersion gave good water and oil barriers.

### Example 15

Various additives were tested to the wax dispersion to study their effect on enhancing oil barrier properties, while maintaining the original water resistance. The wax dispersion was produced by a standard protocol, having maximum particle size of 2 μm and concentration of 10 wt-%:

Briefly, 200 g of wax dispersion was weighed in a PP-container and additives (Table 1) were mixed with magnetic stirring for few minutes, followed by high-shear mixing (17000 rpm 180 w) 3 times 10 sec intervals. For coating tests, the obtained wax mixture was applied on boxboard to obtain 5-10 g/m2 dry coat weight. The samples were put in oven at 109° C. for 1-2 minutes and then allowed to cool to room temperature. A drop of water or rapeseed oil was placed on the coating and allowed to stand for 30 minutes and then visually inspected. All tested additives gave both oil and water resistance. The addition of clay or talc was also useful for increasing the dry-matter content of wax mixtures.

TABLE 1
Various tested additives and their dry composition in mixture.
MFC: microfibrillar cellulose from alkali treated, washed
and bleached sugar beet pulp (produced according to WO2017/103329,
see in particular Example E, sample 202.2). CNF: Cellulose
nanofibrils from sulfate derivatized dissolving pulp (produced
according to WO2018/202955, Example 6, sample SUL-2), POVAL:
polyvinyl alcohol (Kuraray Poval 8-88). Talc: Elementis Finntalc
C15; Kaolin: Imerys Argirec B24.

| Entry | Wax | Additive 1 | Additive 1 | Additive 2 | Additive 2 |
|---|---|---|---|---|---|
| A | 99.0% | POVAL | 1.0% | — | — |
| B | 98.4% | CNF | 1.6% | — | — |
| C | 94.8% | MFC | 5.2% | — | — |
| D | 67.6% | MFC | 1.7% | Talc | 30.7% |
| E | 36.8% | CNF | 0.3% | Kaolin | 62.9% |

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

1. A composition comprising:
a plant-based wax; and
a fibrillated cellulose component; and
wherein the composition is a dispersion of wax particles in an aqueous medium.

2. The composition of claim 1, wherein the fibrillated cellulose component comprises entangled cellulose microfibril aggregates comprising microfibrils and/or microfibril bundles which are smaller than 200 μm.

3. The composition of claim 1 or 2, wherein the plant-based wax comprises triglycerides and/or partially saponified triglyceride, and the plant-based wax is preferably selected from the group consisting of palm wax, palm kernel wax, rapeseed wax, soy wax, corn wax, canola wax, carnauba wax, candelilla wax, ourieury wax, soybean wax, coconut wax, cranbe wax, sunflower wax, linseed wax, cottonseed wax, sugar cane wax, bayberry wax, peanut wax, or a combination thereof.

4. The composition of claim 1 or 2, wherein the plant-based wax comprises partially hydrogenated tall oil acid or completely hydrogenated tall oil acid.

5. The composition of any one of claims 1-4, wherein the plant-based wax comprises a blend of:
triglycerides preferably from the group consisting of palm wax, palm kernel wax, rapeseed wax, soy wax, corn wax, canola wax, carnauba wax, candelilla wax, ourieury wax, soybean wax, coconut wax, cranbe wax, sunflower wax, linseed wax, cottonseed wax, sugar cane wax, bayberry wax, peanut wax, or a combination thereof, or any mixture thereof; and
at least one of fatty acid, partially hydrogenated tall oil acid, completely hydrogenated tall oil acid, crude tall oil, and distilled tall oil.

6. The composition of any one of the claims 1-5, wherein the fibrillated cellulose component is fibrillated parenchymal cellulose.

7. The composition of any one of the claims 1-6, wherein in the fibrillated cellulose component the amount of cellulose is selected from the range 50-70 wt-% dry matter of the fibrillated cellulose component, and the amount of hemicellulose is selected from the range 30-50 wt-% dry matter of the fibrillated cellulose component.

8. The composition of any one of the claims 1-7, wherein the composition further comprises multivalent cations, preferably at least one of Zn²⁺, Mg²⁺, Cu²⁺, Fe²⁺, Fe³⁺, Al³⁺, Sn²⁺, Ca²⁺, a fatty acid salt of the multivalent cation, or any combination thereof.

9. The composition of any one of the claims 1-8, wherein the composition comprises wax particles having a size of less than 20 μm, preferably between 0.1-10 μm, most preferably between 0.5-8 μm.

10. The composition of any one of the claims 1-9, wherein the composition further comprises at least one of the following:
a. thermoplastic polymer, polyolefin dispersion, polyester, polyamide, polycaprolactone, polylactic acid, ethylene copolymer, ethylene terpolymer, polyvinyl acetate latex, ethyl vinyl acetate latex, styrene butadiene latex, styrene acrylate latex, acrylate latex, methyl methacrylate latex, or any mixture, copolymers, or derivative thereof;
b. synthetic wax, polyolefin wax, fatty amide wax, amide wax, inorganically modified wax, oxidized polyethylene wax, or any combination thereof;
c. natural, synthetic or semi-synthetic polymer, carboxymethyl cellulose, hydroxypropyl cellulose, hydroxypropyl methyl cellulose, methyl cellulose, hydroxyethyl cellulose, hydroxyethyl methyl cellulose, hydroxyethyl hydroxypropyl cellulose, quaternized hydroxyethyl cellulose, carboxymethyl starch, hydroxypropyl starch, hydroxypropyl methyl starch, hydroxyethyl starch, hydroxyethyl methyl starch, hydroxyethyl hydroxypropyl starch, hydroxypropyl trimethylammonium chloride starch, dextrin, starch, xanthan gum, guar guar, agar agar, alginate, tylose, polyvinyl alcohol, polyacrylamide, vinyl acetate copolymer, or any combination thereof;
d. non-ionic surfactant, cetyl alcohol, stearyl alcohol, cetostearyl alcohol, alcohol ethoxylate, polyglycol ether, polyoxyethylene alkyl ether, secondary alcohol ethoxylate, polyoxyethylene alkyl ether, polyalkyl glycol alkyl ether, ester of pentaerythritol, sugar ester of pentaerythritol, fatty acid, citric acid, fatty acid citrate, fatty alcohol, or any combination thereof; and/or
e. ionic surfactant containing phosphate, sulfate sulfonate, sulfate carboxylate, sodium lauryl sulfate, ammonium lauryl sulfate, lauryl ether sulfate, lesithin, alkali salt of tall oil, or any combination thereof.

11. A solid wet product obtained by subjecting the composition of any one of the claims 1-10 to a powder-making process.

12. A method for producing the composition of any one of the claims 1-10, comprising:
providing a plant-based wax;
providing a fibrillated cellulose component;
heating the plant-based wax and the fibrillated cellulose component;
adding the fibrillated cellulose component to the plant-based wax while continuously mixing; and
mixing the fibrillated cellulose component and the plant-based wax until a phase transition occurs to obtain a dispersion of wax particles in an aqueous medium.

13. A method for manufacturing the composition of any one of the claims 1-10 comprising:
providing a plant-based wax dispersion;
providing a fibrillated cellulose component; and
adding the fibrillated cellulose component to the dispersion while continuously mixing to obtain a dispersion of wax particles in an aqueous medium.

14. A method for producing a liquid dispersion comprising:
providing the solid wet product of claim 11; and
diluting the solid wet product in an aqueous medium, or heating the solid wet product, to obtain the liquid dispersion.

15. A coating formulation comprising the composition of any one of the claims 1-10.

16. An article of manufacture, wherein the article comprises a cellulosic medium, and wherein the article comprises at least one layer of coating of the composition of any one of the claims 1-10.

17. A food wrapper comprising on at least one side at least one layer of the composition of claims 1-10.

18. Use of the composition of any one of the claims 1-10 in sizing, internal sizing, paper coating, board coating, barrier coating, hydrophobic coating, oleophobic coating, corrugated board production, gypsum board production, wood panel production, hard board production, soft board production, laminated veneer lumber production, and/or chip board production.
